(19) United States
(12) Patent Application Publication
(10) Pub. No.: US 2022/0107598 A1
(43) Pub. Date: Apr. 7, 2022

(54) DRIVING CONTROL OF PRINTING MEDIUM FEEDING DEVICE

(71) Applicant: Hewlett-Packard Development Company, L.P., Spring, TX (US)

(72) Inventors: Jewon Jeong, Pangyo (KR); Uichoon Lee, Pangyo (KR)

(73) Assignee: Hewlett-Packard Development Company, L.P., Spring, TX (US)

(21) Appl. No.: 17/415,122

(22) PCT Filed: Dec. 30, 2019
(86) PCT No.: PCT/US2019/068945

§ 371 Date: Jun. 17, 2021

(30) Foreign Application Priority Data
Jun. 24, 2019 (KR) 10-2019-0075241

(51) Int. Cl. G03G 15/00; B65H 3/52; B65H 7/20; B65H 3/06

(52) U.S. Cl. CPC G03G 15/6511; B65H 3/5215; B65H 7/20; B65H 1/04; B65H 2403/732; B65H 2801/06; B65H 3/0638

(57) ABSTRACT

A printing medium feeding device includes a loading unit into which a printing medium is loaded, a pickup roller which picks up the loaded printing medium, a retard roller, a forward roller engaged with the retard roller to feed the picked-up printing medium in a first direction, a torque limiter to apply torque in a second direction opposite to the first direction to the retard roller, and a processor. The processor controls driving of the forward roller by generating a pre-driving signal to change a torque state of the torque limiter to an effective torque state for preventing multi-feeding of printing media and controls driving of the forward roller by generating a driving signal to feed the printing medium in the first direction.

### BACKGROUND

With the development of image forming apparatuses such as printers, copiers, and multi-function machines, interest in technology for stably separating and supplying sheets of printing paper while supplying printing paper at a high speed to an image forming unit in an image forming apparatus has increased.

### BRIEF DESCRIPTION OF THE DRAWINGS

FIG. 1 is a diagram for describing a schematic structure and operation of an image forming apparatus;

FIG. 2 is a diagram illustrating a printing medium feeding device of an image forming apparatus;

FIG. 3 is a diagram for describing an operation of a printing medium feeding device feeding a printing medium;

FIG. 4 is a diagram for describing an operation of a printing medium feeding device preventing the multi-feeding of printing media;

FIG. 5 is a graph for describing the characteristics of the torque generated in a torque limiter;

FIG. 6 is a diagram for describing a pre-driving signal and a driving signal;

FIG. 7 is a diagram for describing an operation of a printing medium feeding device controlling the driving of a forward roller by a pre-driving signal in a state where a pickup roller is located at an up position spaced apart from a printing medium;

FIG. 8 is a diagram for describing an operation of a printing medium feeding device controlling the driving of a pickup roller and a forward roller by a driving signal in a state where the pickup roller is located at a down position contacting a printing medium;

FIGS. 9A and 9B are diagrams for describing a control method capable of preventing the multi-feeding of printing media by comparing an up/down interval of a pickup roller and a driving interval of a forward roller;

FIG. 10 is a flowchart illustrating a method of controlling a printing medium feeding device; and

FIG. 11 is a block diagram of an image forming apparatus according to an example.

### DETAILED DESCRIPTION

Hereinafter, various examples will be described in detail with reference to the drawings. Also, in the specification and drawings, like reference numerals may denote like elements having substantially the same functions and configurations, and redundant descriptions thereof may be omitted for conciseness.

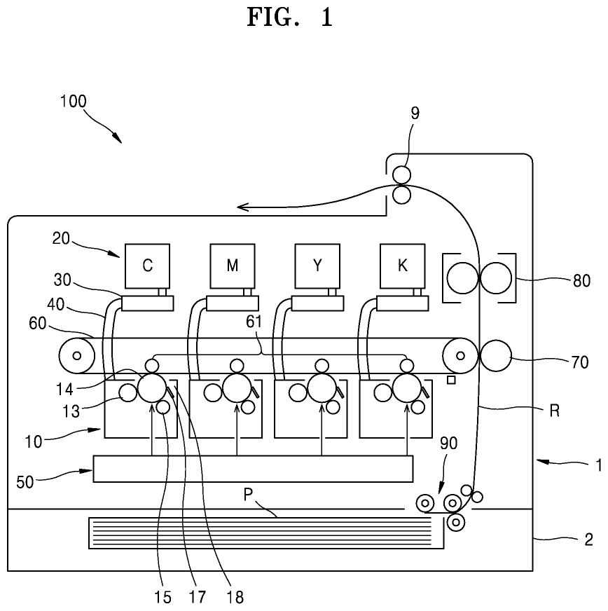

FIG. 1 is a diagram for describing a schematic structure and operation of an image forming apparatus 100 according to an example. The image forming apparatus 100 of the example may print a color image by an electrophotographic development method.

A developing device 10 may include a photoconductor 14 on the surface of which an electrostatic latent image is formed and a developing roller 13 for supplying a developer to an electrostatic latent image to develop the electrostatic latent image into a visible toner image. A photosensitive drum may be an organic photo conductor (OPC), as an example of the photoconductor 14. A charging roller 15 may be an example of a charger for charging the photoconductor 14 to have a uniform surface potential. The developing device 10 may further include a cleaning member 17 or the like for removing the developer remaining on the surface of the photoconductor 14 after an intermediate transfer process. A waste developer may be contained in a waste developer container 18.

The developer contained in a developer cartridge 20 may be supplied to the developing device 10. A developer supply unit 30, which receives a developer from the developer cartridge 20 and supplies the developer to the developing device 10, may be connected to the developing device 10 by a supply pipe 40. The developer contained in the developer cartridge 20 may be a toner.

An exposure device 50 may form an electrostatic latent image on the photoconductor 14 by irradiating the photoconductor 14 with the light modulated corresponding to image information, and a representative example thereof may be a laser scanning unit (LSU) or the like.

A transfer unit may transfer the toner image formed on the photoconductor 14 to a printing medium P and may be an intermediate transfer-type transfer unit. As an example, the transfer unit may include an intermediate transfer member 60, an intermediate transfer roller 61, and a transfer roller 70. An intermediate transfer belt may temporarily receive a toner image, as an example of the intermediate transfer member 60 to which the toner image developed on the photoconductor 14 of a plurality of developing devices 10 is transferred. An intermediate transfer bias for intermediately transferring the toner image developed on the photoconductor 14 to the intermediate transfer member 60 may be applied to a plurality of intermediate transfer rollers 61. The transfer roller 70 may be located to face the intermediate transfer member 60. A transfer bias for transferring the toner image transferred to the intermediate transfer member 60 to the printing medium P may be applied to the transfer roller 70.

A fixing unit 80 may apply heat and/or pressure to the toner image transferred to the printing medium P, to fix the same to the printing medium P.

By the above configuration, the exposure device 50 may scan a plurality of lights modulated corresponding to image information of each color to the photoconductor 14 of a plurality of developing devices 10 to form an electrostatic latent image on the photoconductor 14. The electrostatic latent image of the photoconductor 14 of a plurality of developing devices 10 may be developed into a visible toner image by cyan (C), magenta (M), yellow (Y), and black (K) developers supplied from a plurality of developer cartridges 20 to a plurality of developing devices 10. The developed toner images may be sequentially intermediately-transferred to the intermediate transfer member 60. The printing medium P loaded into a loading unit 2 coupled to a main body 1 may be fed along a paper feed path R by a printing medium feeding device 90 to be fed between the transfer roller 70 and the intermediate transfer member 60. The toner image intermediately-transferred onto the intermediate transfer member 60 by a transfer bias voltage applied to the transfer roller 70 may be transferred to the printing medium P. When the printing medium P passes through the fixing unit 80, the toner image may be fixed to the printing medium P by heat and pressure. The printing medium P on which the fixing is completed may be discharged by a discharge roller 9.

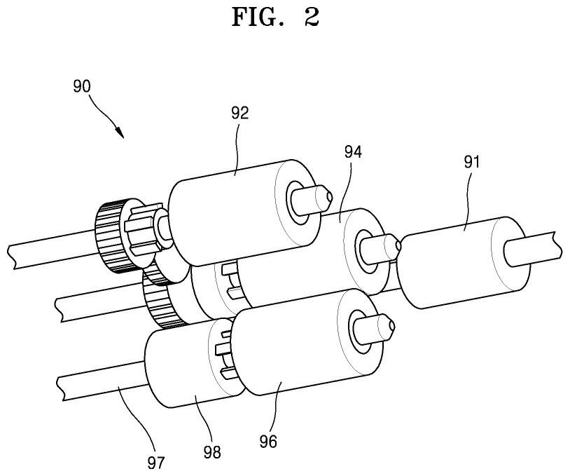

FIG. 2 is a diagram illustrating the printing medium feeding device 90 of the image forming apparatus 100.

Referring to FIG. 2, the printing medium feeding device 90 may be mounted in the main body 1 accommodating a printing device therein, and may pick up the printing medium from the loading unit 2 into which the printing medium is loaded and feed the picked-up printing medium into the image forming apparatus 100.

The printing medium feeding device 90 may include a plurality of rollers such as a pickup roller 92, a forward roller 94, a retard roller 96, and a feed roller 91 for feeding the printing medium.

The pickup roller 92 may pick up the printing medium loaded into the loading unit 2.

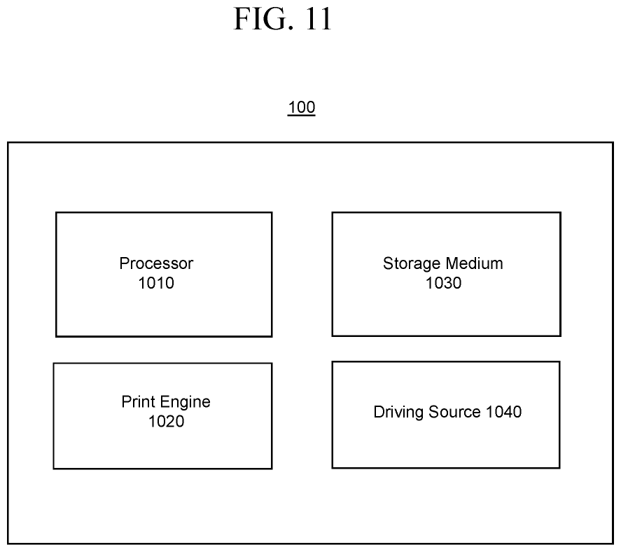

The forward roller 94 may feed the printing medium picked up in engagement with the retard roller 96 in a first direction, to feed the same to the feed roller 91 to be supplied into the image forming apparatus 100. A driving unit (for example, driving source 1040 of FIG. 11) may drive the forward roller 94 to rotate in the feed direction of the printing medium and may drive the pickup roller 92 connected to the forward roller 94 by a connection gear. The driving unit (for example, driving source 1040 of FIG. 11) may include a motor to which a step motor or a clutch is connected, and may further include another motor or a power transmission member such as a connection gear, when necessary.

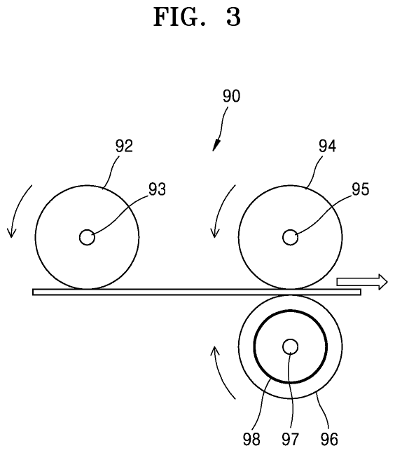

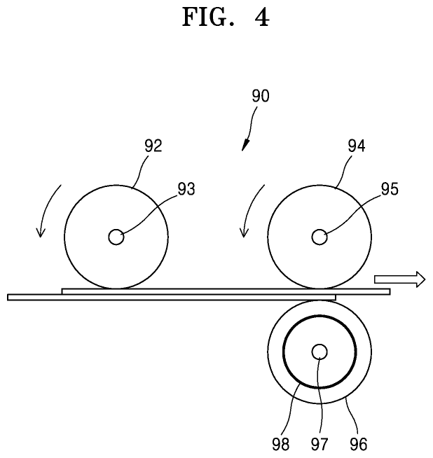

The retard roller 96 may engage with the forward roller 94 and contact the printing medium. A retard shaft 97 may pass through a central axis of the retard roller 96. A torque limiter 98 may be provided at the retard shaft 97 and connected to the retard roller 96, and may apply a torque in a second direction opposite to the first direction to the retard roller 96. An operation of the printing medium feeding device 90 will be described below with reference to FIGS. 3 and 4.

FIG. 3 is a diagram for describing an operation of the printing medium feeding device 90 feeding a printing medium. FIG. 4 is a diagram for describing an operation of the printing medium feeding device 90 preventing the multi-feeding of printing media.

Referring to FIGS. 3 and 4, the printing medium feeding device 90 may include a pickup roller 92, a forward roller 94, and a retard roller 96, a pickup shaft 93, a forward shaft 95, and a retard shaft 97 respectively passing therethrough, and a torque limiter 98 provided at the retard shaft 97 and connected to the retard roller 96. The printing medium feeding device 90 may include a driving unit (for example, driving source 1040 of FIG. 11) for driving the forward roller 94 and the pickup roller 92. It may further include a processor (for example, processor 1010 of FIG. 11) for controlling the driving of the forward roller 94 by a pre-driving signal for making a torque state of the torque limiter 98 become an effective torque state for preventing the multi-feeding of printing media and a driving signal for feeding the printing medium in the first direction.

Referring to FIG. 3, the forward roller 94 may be rotated on the forward shaft 95 by the driving unit (for example, driving source 1040 of FIG. 11). According to the rotation of the forward roller 94, the pickup shaft 93 and the pickup roller 92 connected by a connection gear (not illustrated) may also rotate in the same direction as the rotation direction of the forward roller 94. In another example, a separate pickup motor (not illustrated) for driving the pickup roller 92 may be provided. The pickup motor (not illustrated) may be driven according to a pickup request signal, may stop driving when the printing medium reaches the feed roller 91, and may wait until receiving a next pickup request signal. According to the rotation of the pickup roller 92, among the printing media loaded into the loading unit 2, the printing medium contacting the pickup roller 92 may be picked up, and the picked-up printing medium may be transmitted in the rotation direction of the pickup roller 92, that is, the feed direction of the printing medium. The forward roller 94 may feed the printing medium transmitted from the pickup roller 92 in the first direction. As illustrated in FIG. 3, when printing media are normally fed one by one without multi-feeding of printing media, because a torque value due to the frictional force between the retard roller 96 and the printing medium is greater than a threshold torque value of the torque limiter 98, the retard roller 96 may rotate on the retard shaft 97 in the feed direction of the printing medium, that is, in the direction opposite to the rotation direction of the forward roller 94. As the forward roller 94 rotates counterclockwise and the retard roller 96 rotates clockwise, the printing medium may be fed in the feed direction of the printing medium.

Referring to FIG. 4, when two printing media are inserted into a nip formed by the forward roller 94 and the retard roller 96, the torque limiter 98 may apply a torque in a second direction opposite to the first direction to the retard roller 96, thereby preventing the two printing media from passing therethrough at once. The multi-feeding of printing media may be prevented by the relationship between the frictional force between the retard roller 96 and the printing medium contacting the retard roller 96 (among the two printing media), the frictional force between the two printing media, and the torque in the second direction provided to the retard roller 96 by the torque limiter 98. Because the frictional force between the forward roller 94 and the printing medium is greater than the frictional force between the two printing media and the frictional force between the retard roller 96 and the printing medium is greater than the frictional force between the two printing media, a slip may occur between the two printing media. The retard roller 96 may not be rotated because the torque value applied to the retard roller 96 by the frictional force between the retard roller 96 and the printing medium is smaller than the threshold torque value of the torque limiter 98. As a result, among the two printing media, the printing medium contacting the forward roller 94 may be fed and the printing medium contacting the retard roller 96 may not be fed but kept in the nip, thereby preventing the multi-feeding of printing media.

The torque limiter 98 may have a certain threshold torque value. When the torque value applied to the retard roller 96 according to the rotation of the forward roller 94 is greater than the threshold torque value of the torque limiter 98, the retard roller 96 may be rotated in the feed direction of the printing medium, that is, in the direction opposite to the rotation direction of the forward roller 94. On the other hand, when the torque value applied to the retard roller 96 according to the rotation of the forward roller 94 is smaller than the threshold torque value of the torque limiter 98, the torque limiter 98 may apply a torque to the retard roller 96 in the second direction and thus the retard roller 96 may not rotate in the feed direction of the printing medium.

Because the retard roller 96 is connected to the torque limiter 98 provided at the retard shaft 97, the rotation of the retard roller 96 may be affected by the characteristics of the torque limiter 98.

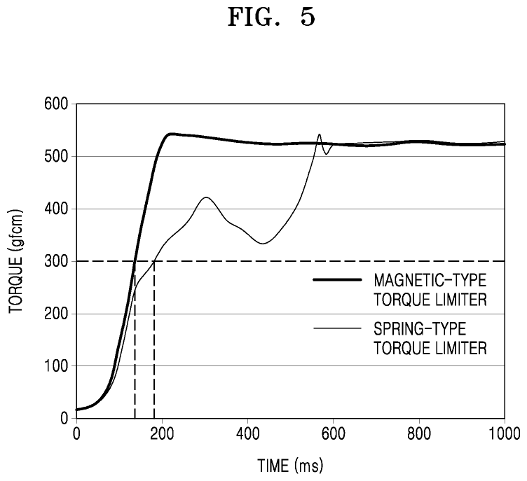

FIG. 5 is a graph for describing the characteristics of the torque generated in the torque limiter 98.

Referring to FIG. 5, it may be seen that torque values are generated in the torque limiter 98 with time when there is a gradual acceleration rotation of the forward roller 94. FIG. 5 illustrating a graph showing the torque values generated in different types of two torque limiters 98, one of which is a magnetic type and the other of which is a spring type. It may be seen that the two types of torque limiters 98 have a tendency of a gradual increase in the torque value generated with time and it converges to a certain threshold torque value. It may be seen that the magnetic type reaches the threshold torque value within a shorter time than the spring type.

As described above with reference to FIGS. 3 and 4, when a torque value applied to the retard roller 96 by the rotation of the forward roller 94 is greater than a threshold torque value of the torque limiter 98 connected to the retard roller 96, the retard roller 96 may rotate in the feed direction of the printing medium, that is, in the first direction, and when the torque value is smaller than the threshold torque value, the retard roller 96 may not rotate in the first direction even when a torque is applied to the retard roller 96 in the second direction. However, when a plurality of printing media are inserted in a situation where a torque smaller than a minimum torque necessary for printing medium separation is generated in the torque limiter 98, the retard roller 96 may not separate the plurality of printing media by a small torque applied to the retard roller 96 from the torque limiter 98 and thus multi-feeding of printing media may occur. Referring to the graph of FIG. 5, it may be seen that, when a minimum torque value for separating the printing media is 300 gfcm, for two types of torque limiters 98 a time of between about 100 ms and about 200 ms elapses until the minimum torque value occurs. That is, it may be seen that a driving unit (for example, driving source 1040 of FIG. 11) drives the forward roller 94 according to a driving signal for feeding the printing medium and a certain preparation time elapses until the retard roller 96 is ready to separate the printing media according to the rotation of the forward roller 94. In order to prevent the multi-feeding of printing media during the preparation time, a method in which the torque limiter 98 pre-secures a torque necessary for printing medium separation may be considered. Hereinafter, a description will be given of examples of preventing the multi-feeding of printing media by preparing in advance the torque limiter 98 for applying a torque to the retard roller 96 in the direction opposite to the printing medium feed direction before controlling the driving of the forward roller 94 by the driving signal for feeding the printing medium.

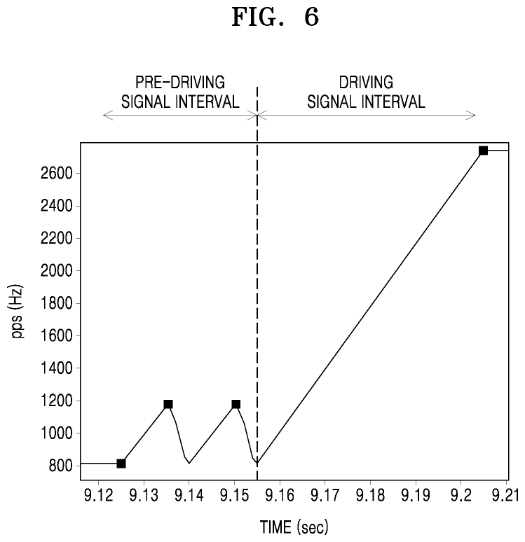

FIG. 6 is a diagram for describing the pre-driving signal and the driving signal.

Due to the characteristics of the torque generated in the torque limiter 98 described above with reference to FIG. 5, in order to prevent the multi-feeding of printing media that may occur in initial driving of the printing medium feeding device 90, the processor (for example, processor 1010 of FIG. 11) of the image forming apparatus 100 may control the driving of the forward roller 94 by generating and transmitting a pre-driving signal for making or changing a torque state of the torque limiter 98 to become an effective torque state for preventing the multi-feeding of printing media and generating and transmitting a driving signal for feeding the printing medium. Making or changing the torque state of the torque limiter 98 to become the effective torque state may refer to forming, in the torque limiter 98, a certain torque corresponding to a value that is equal to or greater than a minimum torque value capable of separating the printing media and is equal to or smaller than a threshold torque value of the torque limiter 98. When the torque state of the torque limiter 98 is in the effective torque state, a torque formed at the torque limiter 98 in the direction opposite to the feed direction of the printing medium may be applied to the retard roller 96 connected to the torque limiter 98 and thus the retard roller 96 may separate the printing media.

The torque limiter 98 may enter the effective torque state when a torque in the second direction is formed by the movement of the retard roller 96 according to the rotation of the forward roller 94 by the pre-driving signal. The processor (for example, processor 1010 of FIG. 11) may transmit the pre-driving signal to the driver (for example, driving source 1040 of FIG. 11) before transmitting the driving signal to the driver (for example, driving source 1040 of FIG. 11), to form a torque in the second direction at the torque limiter 98 by the movement of the retard roller 96 according to the rotation of the forward roller 94 in the first direction. The processor (for example, processor 1010 of FIG. 11) may control the driving of the forward roller 94 by the pre-driving signal and then control the drive of the forward roller 94 by the driving signal when the torque state of the torque limiter 98 becomes the effective torque state for preventing the multi-feeding of printing media and thus the retard roller 96 is ready to separate a plurality of printing media.

The processor (for example, processor 1010 of FIG. 11) of the image forming apparatus 100 may control the driving of the forward roller 94 by the driving signal for accelerating gradually up to a certain speed, for example a predetermined speed, after controlling the driving of the forward roller 94 by the pre-driving signal for accelerating/decelerating the forward roller 94 one or more times when the printing medium is picked up. A maximum speed during the acceleration and deceleration by the pre-driving signal may be lower than a certain speed that may be reached by the driving signal. Referring to FIG. 6, a pre-driving signal interval for repeating acceleration and deceleration a plurality of times during the pickup of the printing medium and a driving signal interval for accelerating gradually for the feeding of the printing medium are illustrated. In the pre-driving signal interval, as the driving speed of the driving unit (for example, driving source 1040 of FIG. 11) for driving the forward roller 94 is accelerated and decelerated a plurality of times, when the retard roller 96 engaged with the forward roller 94 moves, the torque limiter 98 may secure a torque in the second direction for separating the printing media. As a result, a torque in the second direction may be formed in the torque limiter 98 due to the pre-driving signal and thus a torque in the second direction may be applied to the retard roller 96.

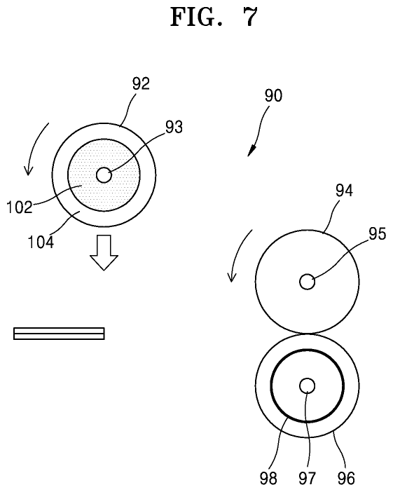

Meanwhile, in the case of a structure in which the pickup roller 92 may move to a down position contacting a printing medium loaded into the loading unit 2 and to an up position spaced apart from the printing medium, instead of controlling the driving of the forward roller 94 by the pre-driving signal in the form of accelerating/decelerating the forward roller 94 one or more times described with reference to FIG. 6, the processor (for example, processor 1010 of FIG. 11) may adjust the position of the pickup roller 92 when controlling the driving of the forward roller 94 by the pre-driving signal and when controlling the driving of the forward roller 94 by the driving signal to make the torque state of the torque limiter 98 become the effective torque state for preventing the multi-feeding of printing media and then pick up and feed the printing medium. Related examples thereof will be described below with reference to FIGS. 7 to 9.

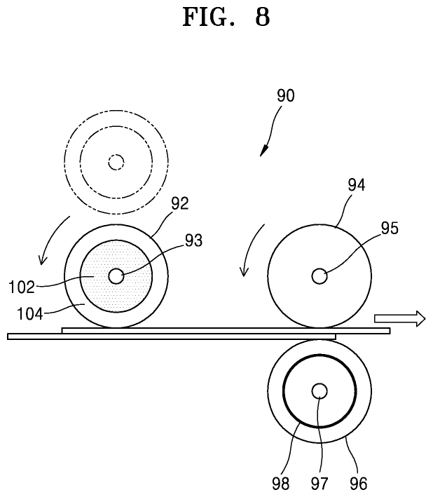

FIG. 7 is a diagram for describing an operation of the printing medium feeding device 90 controlling the driving of the forward roller 94 by the pre-driving signal in a state where the pickup roller 92 is located at the up position spaced apart from the printing medium. FIG. 8 is a diagram for describing an operation of the printing medium feeding device 90 controlling the driving of the pickup roller 92 and the forward roller 94 by the driving signal in a state where the pickup roller 92 is located at the down position contacting the printing medium.

Referring to FIGS. 7 and 8, the printing medium feeding device 90 may include the pickup roller 92, the forward roller 94, and the retard roller 96, the pickup shaft 93, the forward shaft 95, and the retard shaft 97 respectively passing therethrough, and the torque limiter 98. An impact mitigating member may be included in the pickup roller 92 to reduce a reaction due to an impact caused by the up/down of the pickup roller 92. As an example, the pickup roller 92 may be a roller having a multilayer structure. The pickup roller 92 may include an inner layer 102 including an impact mitigating member that is a porous material such as a sponge, and an outer layer 104 contacting the printing medium. The outer layer 104 may be a layer of an elastic material, for example, a rubber material.

Referring to FIG. 7, the printing medium feeding device 90 may control the driving of the forward roller 94 by the pre-driving signal in a state where the pickup roller 92 operating in an up/down manner is located at an up position spaced apart from the printing medium. According to the rotation of the forward roller 94, the pickup shaft 93 and the pickup roller 92 connected by a connection gear (not illustrated) may also rotate in the same direction as the rotation direction of the forward roller 94. Even when the pickup roller 92 rotates, the printing medium may not be picked up because the pickup roller 92 is spaced apart from the printing medium. Meanwhile, a torque in the second direction may be formed at the torque limiter 98 by the movement of the retard roller 96 according to the rotation of the forward roller 94 in the first direction, and thus the torque state of the torque limiter 98 may become the effective torque state for preventing the multi-feeding of printing media.

Referring to FIG. 8, in order to pick up the printing medium, the printing medium feeding device 90 may control the driving of the forward roller 94 by the driving signal in a state where the pickup roller 92 operating in an up/down manner is located at a down position contacting the printing medium. Because the pickup roller 92 is a roller having a multi layer structure including an impact mitigating member, the impact during the down of the pickup roller 92 according to a pickup command may be reduced. Even when a plurality of printing media is inserted into the nip between the forward roller 94 and the retard roller 96, because the impact is reduced due to the structure of the pickup roller 92 and the torque limiter 98 is in the effective torque state due to the rotation of the forward roller 94 in the first direction by the pre-driving signal, the multi-feeding of printing media may be prevented from occurring.

Referring to FIGS. 7 and 8, the processor (for example, processor 1010 of FIG. 11) of the image forming apparatus 100 may control the driving of the pickup roller 92 and the forward roller 94 by the driving signal in a state where the pickup roller 92 is located at the down position contacting the printing medium, after controlling the driving of the forward roller 94 by the pre-driving signal in a state where the pickup roller 92 is located at the up position spaced apart from the printing medium.

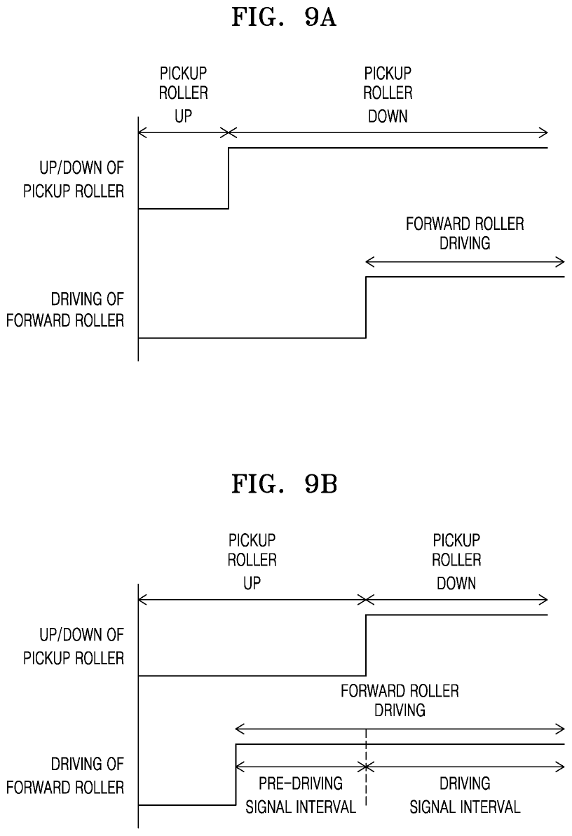

FIGS. 9A and 9B are diagrams for describing a control method capable of preventing the multi-feeding of printing media by comparing an up/down interval of the pickup roller 92 and a driving interval of the forward roller 94.

The up/down of the pickup roller 92 may be performed by operating a solenoid device (not illustrated); however, a device for adjusting the position of the pickup roller 92 is not limited to the solenoid device and it may be performed by using various types of actuators. When the device for adjusting the position of the pickup roller 92, for example, the solenoid device, is operated according to a signal for driving the solenoid device, the pickup roller 92 may be located from the up position to the down position.

In the case of FIG. 9A, when comparing the time of lowering the pickup roller 92 to contact the printing medium with the time of driving the forward roller 94, it may be seen that the time of lowering the pickup roller 92 is earlier. In FIG. 9A, because the pickup roller 92 drives the forward roller 94 in a state where the pickup roller 92 is lowered to contact the printing medium, until the torque limiter 98 secures a minimum torque necessary for printing medium separation, the multi-feeding of printing media may occur in the initial driving of the printing medium feeding device 90.

On the other hand, in the case of FIG. 9B, when comparing the time of lowering the pickup roller 92 to contact the printing medium with the time of driving the forward roller 94, it may be seen that the time of driving the forward roller 94 is earlier. By locating the pre-driving signal interval before the driving signal interval, the forward roller 94 may be driven earlier. In the pre-driving signal interval, the pickup roller 92 may be located at the up position spaced apart from the printing medium, and in the driving signal interval, the pickup roller 92 may be located from the up position to the down position according to a signal for driving the device for adjusting the position of the pickup roller 92 and the driving of the pickup roller 92 and the forward roller 94 may be controlled to pick up and feed the printing medium. In FIG. 9B, because the torque limiter 98 secures a minimum torque necessary for printing medium separation in the pre-driving signal interval, even when the pickup roller 92 is located at the down position in the driving signal interval to pick up and feed the printing medium, the multi-feeding of printing media, which may occur in the initial driving of the printing medium feeding device 90, may be prevented.

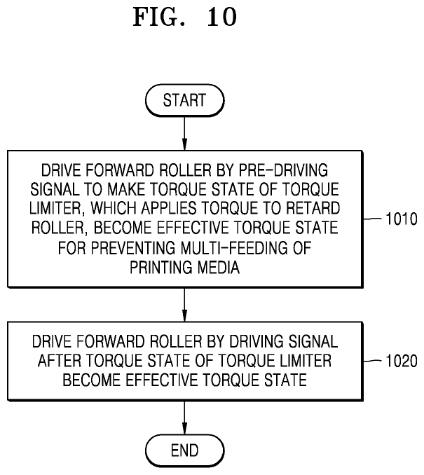

FIG. 10 is a flowchart illustrating a method of controlling the printing medium feeding device 90.

Even when any portion of the above description of the printing medium feeding device 90 or the image forming apparatus 100 is omitted below, it may also be similarly applied to the method of controlling the printing medium feeding device 90.

In block 1010, the printing medium feeding device 90 may drive the forward roller 94, which is engaged with the retard roller 96 to feed the printing medium in the first direction, by the pre-driving signal in the first direction, to make the torque state of the torque limiter 98, which applies a torque in the second direction opposite to the first direction to the retard roller 96, become the effective torque state for preventing the multi-feeding of printing media.

For example, the printing medium feeding device 90 may drive the forward roller 94 by the pre-driving signal for accelerating/decelerating the forward roller 94 one or more times when picking up the printing medium, to make the torque state of the torque limiter 98 become the effective torque state for preventing the multi-feeding of printing media.

As another example, the printing medium feeding device 90 may make the torque state of the torque limiter 98 become the effective torque state for preventing the multi-feeding of printing media, by driving the forward roller 94 by the pre-driving signal in a state where the pickup roller 92 is located at the up position spaced apart from the printing medium loaded into the loading unit 2.

In block 1020, the printing medium feeding device 90 may drive the forward roller 94 by the driving signal for feeding the printing medium in the first direction, after the torque state of the torque limiter 98 becomes the effective torque state.

For example, according to a signal for driving a device for adjusting the position of the pickup roller 92, the printing medium feeding device 90 may locate the pickup roller 92 from the up position to the down position contacting the printing medium loaded into the loading unit and drive the pickup roller 92 and the forward roller 94 by the driving signal.

FIG. 11 is a block diagram of an image forming apparatus according to an example.

Referring to FIG. 11, the image forming apparatus 100 may include a processor 1010, a print engine 1020, a storage medium 1030, and a driving source 1040.

The processor 1010 may execute instructions stored in the storage medium 1030. The processor 1010 may include, for example, an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, or combinations thereof.

The print engine 1020 may perform an image forming job by forming an image on a printing medium to perform a job such as printing, copying, and faxing, for example. The print engine 1020 which receives a control signal from the processor 1010 to perform an image forming or printing operation. The print engine 1020 may also be referred to as an image forming unit.

Meanwhile, the above method of controlling the printing medium feeding device 90 may be implemented in the form of a computer-readable storage medium 1030, for example a non-transitory computer-readable storage medium, storing instructions or data executable by a computer or a processor 1010. It may be written as a program executable in a computer and may be implemented in a general-purpose digital computer that operates the program by using a computer-readable storage medium. The computer-readable storage medium may be non-transitory and may include a Read-Only Memory (ROM), Random-Access Memory (RAM), flash memory, Compact Disk Read-Only Memory (CD−ROM), Compact Disk Recordable (CD−R), CD+R, Compact Disk Rewritable (CD−RW), CD+RW, Digital Versatile Disk Read-Only Memory (DVD−ROM), Digital Versatile Disk Recordable (DVD−R), DVD+R, Digital Versatile Disk Rewritable (DVD−RW), DVD+RW, Digital Versatile Disk Random-Access Memory (DVD−RAM), Blu-ray Disk Read-Only Memory (BD−ROM), Blu-ray Disk Recordable (BD−R), Blu-ray Disk Recordable Low to High (BD−R LTH), Blu-ray Disk Recordable Erasable (BD-RE), magnetic tapes, floppy disks, magneto-optical data storages, optical data storages, hard disks, Solid-State Disk (SSD), or any device that may store instructions or software, related data, data files, and data structures and may provide instructions or software, related data, data files, and data structures to a processor 1010 or computer to enable the processor 1010 or computer to execute instructions.

The driving source 1040 may be coupled directly or indirectly to a rotatable shaft to rotate a body, for example the forward roller 94 and/or pickup roller 92 of the image forming apparatus 100. The driving source 1040 may include a motor, a solenoid, another electromechanical device, or combinations thereof. For example, the driving source 1040 may include a motor, a gear coupled to a rotatable shaft, and a driving belt coupling the motor to the gear to drive rotation of the rotatable shaft according to a signal, for example the pre-driving and/or driving signal, output from the processor 1010. The rotatable shaft may be rotated in a first direction and a second direction by the driving source 1040. The first direction may be referred to as a “forward” direction and the second direction may be referred to as a “reverse” direction. The driving source 1040 may be provided to drive more than one body. For example, a single driving source may be provided to cause more than one body to move or rotate.

While this disclosure has been shown and described with reference to examples thereof, it will be understood that various changes in form and details may be made therein without departing from the spirit and scope of the disclosure as defined by the appended claims.

What is claimed is:

1. A printing medium feeding device, comprising:
a loading unit to accommodate a printing medium;
a pickup roller to pick up the printing medium from the loading unit when the printing medium is accommodated in the loading unit;
a retard roller;
a forward roller to engage with the retard roller to feed the printing medium, picked up by the pickup roller, in a first direction;
a torque limiter to apply torque in a second direction opposite to the first direction to the retard roller; and
a processor to control driving of the forward roller by generating a pre-driving signal to change a torque state of the torque limiter to an effective torque state for preventing multi-feeding of printing media, and to control driving of the forward roller by generating a driving signal to feed the printing medium in the first direction.

2. The printing medium feeding device of claim 1, wherein
the torque limiter is to change to the effective torque state according to a torque in the second direction caused by movement of the retard roller, when the forward roller is rotated based on the pre-driving signal.

3. The printing medium feeding device of claim 1, wherein
the processor is to control the driving of the forward roller by generating the driving signal such that the forward roller is accelerated to a predetermined speed, after controlling the driving of the forward roller by generating the pre-driving signal such that the forward roller is accelerated and/or decelerated at least one or more times when the printing medium is picked up by the pickup roller.

4. The printing medium feeding device of claim 3, wherein
a maximum speed of the forward roller when the forward roller is accelerated and/or decelerated according to the pre-driving signal, is lower than the predetermined speed.

5. The printing medium feeding device of claim 1, wherein
the pickup roller is movable to a down position at which the pickup roller contacts the printing medium when the printing medium is accommodated in the loading unit, and to an up position spaced apart from the printing medium when the printing medium is accommodated in the loading unit, and
the processor is to control the driving of the pickup roller and the forward roller by generating the driving signal in a state where the pickup roller is located at the down position, after controlling the driving of the forward roller by generating the pre-driving signal in a state where the pickup roller is located at the up position.

6. The printing medium feeding device of claim 5, wherein
the pickup roller includes an inner layer including an impact mitigating member and an outer layer contacting the printing medium.

7. An image forming apparatus, comprising:
a main body to accommodate a printer therein;
a loading unit to accommodate a printing medium;
a pickup roller to pick up the printing medium from the loading unit when the printing medium is accommodated in the loading unit;
a retard roller;
a forward roller to engage with the retard roller to feed the printing medium, picked up by the pickup roller, in a first direction;
a torque limiter to apply torque in a second direction opposite to the first direction to the retard roller; and
a processor to control driving of the forward roller by generating a pre-driving signal to change a torque state of the torque limiter to an effective torque state for preventing multi-feeding of printing media, and to control driving of the forward roller by generating a driving signal to feed the printing medium in the first direction.

8. The image forming apparatus of claim 7, wherein
the torque limiter is to change to the effective torque state according to a torque in the second direction caused by movement of the retard roller, when the forward roller is rotated based on the pre-driving signal.

9. The image forming apparatus of claim 7, wherein
the processor is to control the driving of the forward roller by generating the driving signal such that the forward roller is accelerated to a predetermined speed, after controlling the driving of the forward roller by generating the pre-driving signal such that the forward roller is accelerated and/or decelerated at least one or more times when the printing medium is picked up by the pickup roller.

10. The image forming apparatus of claim 9, wherein
a maximum speed of the forward roller when the forward roller is accelerated and/or decelerated according to the pre-driving signal, is lower than the predetermined speed.

11. The image forming apparatus of claim 7, wherein
the pickup roller is movable to a down position at which the pickup roller contacts the printing medium when the printing medium is accommodated in the loading unit, and to an up position spaced apart from the printing medium when the printing medium is accommodated in the loading unit, and
the processor is to control the driving of the pickup roller and the forward roller by generating the driving signal in a state where the pickup roller is located at the down position, after controlling the driving of the forward roller by generating the pre-driving signal in a state where the pickup roller is located at the up position.

12. The image forming apparatus of claim 11, wherein
the pickup roller includes an inner layer including an impact mitigating member and an outer layer contacting the printing medium.

13. A method of controlling a printing medium feeding device, the method comprising:
driving a forward roller, which is engaged with a retard roller to feed a printing medium in a first direction, by generating a pre-driving signal to change a torque state of a torque limiter, which applies torque in a second direction opposite to the first direction to the retard roller, to an effective torque state for preventing multi-feeding of printing media; and
driving the forward roller by generating a driving signal to feed the printing medium in the first direction, after the torque state of the torque limiter is changed to the effective torque state.

14. The method of claim 13, wherein
changing the torque state of the torque limiter to the effective torque state includes driving the forward roller by generating the pre-driving signal such that the forward roller is accelerated and/or decelerated at least one or more times when the printing medium is picked up by a pickup roller.

15. The method of claim 13, wherein
changing the torque state of the torque limiter to the effective torque state includes driving the forward roller by generating the pre-driving signal in a state where a pickup roller is located at an up position spaced apart from the printing medium when the printing medium is loaded into a loading unit, and
driving the forward roller by generating the driving signal includes positioning the pickup roller from the up position to a down position at which the pickup roller contacts the printing medium when the printing medium is loaded into the loading unit, and driving the pickup roller and the forward roller by generating the driving signal.
